(19) United States
(12) Patent Application Publication
(10) Pub. No.: US 2010/0127839 A1
(43) Pub. Date: May 27, 2010

(54) METHOD OF OPERATING RADIO FREQUENCY IDENTIFICATION DEVICE AND RADIO FREQUENCY IDENTIFICATION SYSTEM INCLUDING RADIO FREQUENCY IDENTIFICATION DEVICE

(76) Inventors: Iljong SONG, Yongin-si (KR); Sigyoung Koo, Seoul (KR); Jihun Koo, Yongin-si (KR); Kuang Woo Nam, Suwon-si (KR); Younghoon Min, Anyang-si (KR); Chundeok Suh, Yongin-si (KR)

Correspondence Address: HARNESS, DICKEY & PIERCE, P.L.C., P.O. BOX 8910, RESTON, VA, 20195, US

(21) Appl. No.: 12/582,743

(22) Filed: Oct. 21, 2009

(30) Foreign Application Priority Data
Nov. 25, 2008 (KR) 10-2008-0117491

(51) Int. Cl. G06K 7/01

(52) U.S. Cl. 340/10.51

(57) ABSTRACT

The present invention relates to a Radio Frequency Identification (RFID) system. The RFID system includes one or more RFID tags and an RFID device for accessing the RFID tags. The RFID device compares a size of data to be stored in the RFID tags with a storage capacity of the RFID tags and divides the data based on compared results to write in one or more RFID tags.

### CROSS-REFERENCE TO RELATED APPLICATIONS

This U.S. nonprovisional patent application claims priority under 35 U.S.C. §119 to Korean Patent Application 10-2008-0117491, filed on Nov. 25, 2008, in the Korean Intellectual Property Office (KIPO), the entire contents of which is incorporated herein by reference.

### BACKGROUND OF THE INVENTION

Example embodiments relate to a method of operating a radio frequency identification device and a radio frequency identification system including the radio frequency identification device.

The Radio Frequency Identification (hereinafter, referred to as an RFID) is a non-contact identification system that exchanges information between the RFID device and the RFID tag using a radio frequency. The RFID device transmits modulation signals and continuous signals to the RFID tag. The modulation signals send data from the RFID device to the RFID tag, while the continuous signals receive response signals from the RFID tag.

When the RFID device transmits the modulation signals, the RFID tag receives the data transmitted through the modulation signals from the RFID device. When the RFID device transmits the continuous signals, the RFID tag generates response signals by adjusting the amplitude, phase, or frequency of continuous signals. The response signals are transmitted to the RFID device.

### SUMMARY OF THE INVENTION

Example embodiments are directed to RFID device and system having an improved data storing efficiency.

Example embodiments provide an RFID system including one or more RFID tags and an RFID device for accessing the RFID tags. The RFID device compares a size of data to be stored in the RFID tags with a storage capacity of the RFID tags and divides the data based on compared results to write in the RFID tags.

According to an example embodiment, the RFID device may divide the data when the size of the data is larger than the storage capacity of the RFID tags.

According to an example embodiment, the RFID device may write the data in one RFID tag when the size of the data is less than the storage capacity of one of the RFID tags.

According to an example embodiment, the RFID device may write division information in the RFID tags, the division information indicating that the data is divided to be stored in the RFID tags. In addition, the division information may include the number of RFID tags in which the data is divided and written and information indicating which of the divided data is written.

According to an example embodiment, the RFID device may read the divided and written data from the RFID tags based on the division information. The RFID device may combine the read data based on the division information. Furthermore, the RFID device may read the divided and written data depending on a division sequence, store the read data in a buffer, and complete readout when all of the divided data are stored.

Example embodiments provide a method of operating an RFID device including dividing a data to be stored in one or more RFID tags and transmitting the divided data to the RFID tags so as to write the divided data in the RFID tags.

According to an example embodiment, the method may further include reading the written data from the one or more RFID tags and combining the read data to output as a read data.

### BRIEF DESCRIPTION OF THE DRAWINGS

Example embodiments will be more clearly understood from the following brief description taken in conjunction with the accompanying drawings. FIGS. 1-7 represent non-limiting, example embodiments as described herein.

FIG. 1 is a block diagram illustrating an RFID system according to an example embodiment.

FIG. 2 is a flowchart explaining a writing operation of the RFID system of FIG. 1.

FIGS. 3 and 4 are diagrams illustrating the operation of the RFID system according to the flowchart of FIG. 2, respectively.

FIG. 5 is a flowchart explaining a reading operation of the RFID system of FIG. 1.

FIGS. 6 and 7 are diagrams illustrating the operation of the RFID system according to the flowchart of FIG. 5, respectively.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF PREFERRED EMBODIMENTS

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural fowls as well, unless the context clearly indicates otherwise. It will be further understood that the teens “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

According to an example embodiment, an RFID system includes at least one RFID tag and an RFID device for accessing the RFID tag. The RFID device compares sizes of data to be stored in the RFID tag with the storage capacity of the RFID tag and divides the data based on compared results to store in at least one RFID tag. According to the example embodiment, a method of operating an RFID device includes dividing data to be stored in RFID tags and transmitting the divided data to the RFID tags so as to write in the RFID tags.

Hereinafter, example embodiments will be described in detail by explaining example embodiments with reference to the accompanying drawings. These example embodiments are provided so that this disclosure will be thorough and complete, and will fully convey the scope of the invention to those skilled in the art.

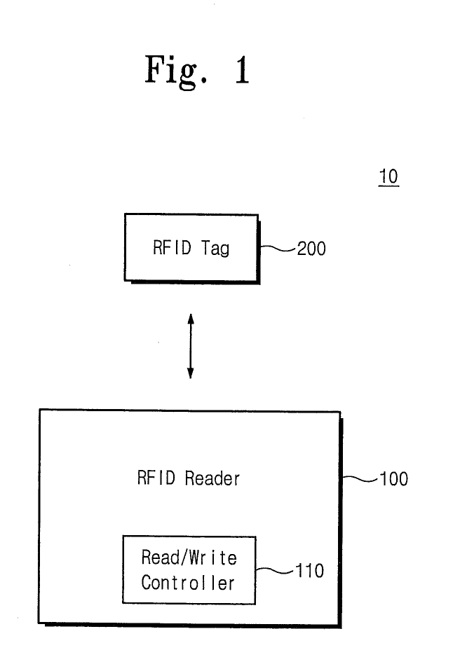

FIG. 1 is a block diagram illustrating an RFID system 10 according to an example embodiment. Referring to FIG. 1, the RFID system 10 includes an RFID device 100 and an RFID tag 200.

The RFID tag 200 receives transmission signals from the RFID device 100. Moreover, the RFID tag 200 modulates continuous signals transmitted from the RFID device 100 and then generates response signals. The response signals are transmitted to the RFID device 100. The transmission signals and continuous signals are transmitted to the RFID tag 200 by the RFID device 100. The transmission signals are required for transmitting data to the RFID tag 200. The continuous signals are required in order for the RFID tag 200 to generate the response signals. For example, the RFID device 100 is referred to as an RFID reader. However, the RFID device 100 is not limited to the RFID reader. The RFID device 100 may include many types of devices for accessing the RFID tag 200.

The RFID device 100 includes a read/write controller 110. The read/write controller 110 may control the operation in which the RFID device 100 reads the data stored in the RFID tag 200 and in which the RFID device 100 writes the data in the RFID tag 200. For example, the read/write controller 110 may be a physically configured circuit. In another example, the read/write controller 110 may be software in the RFID device 100. As another example, the read/write controller 110 may be configured such that some functions are carried out by the hardware and other functions are carried out by the software. For example, the RFID device 100 may communicate with the RFID tag 200 through an inductive coupling or a backscattering.

An RFID tag that performs more improved functions in addition to the function for storing only ID has been developed. An EPCGlobal (Electronic Product Code Global) has proposed, for example, an RFID tag (Class 2) having an extended memory storing capacity, an RFID tag (Class 3) including sensors and having Sleep mode and Wake mode, and an RFID tag (Class 4) including a network function capable of communicating with another RFID tag.

The RFID tag has a limited storage capacity due to the restriction of size and cost. Therefore, a new RFID system is required to effectively use the limited storage capacity of the RFID tag. The RFID device 100 according to the example embodiment divides data to store the data in the RFID tags and transmits the divided data to each of the RFID tags so as to write the divided data in the RFID tags, thereby effectively storing the data in the RFID tags.

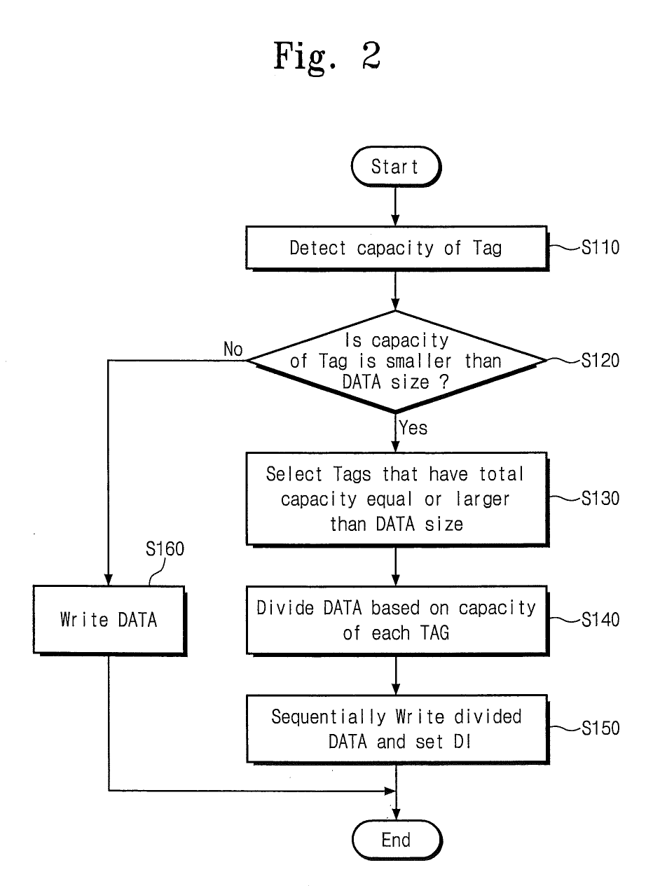

The RFID system 10 and the RFID device 100 according to the example embodiment will be described more fully below with reference to FIGS. 2 to 7.

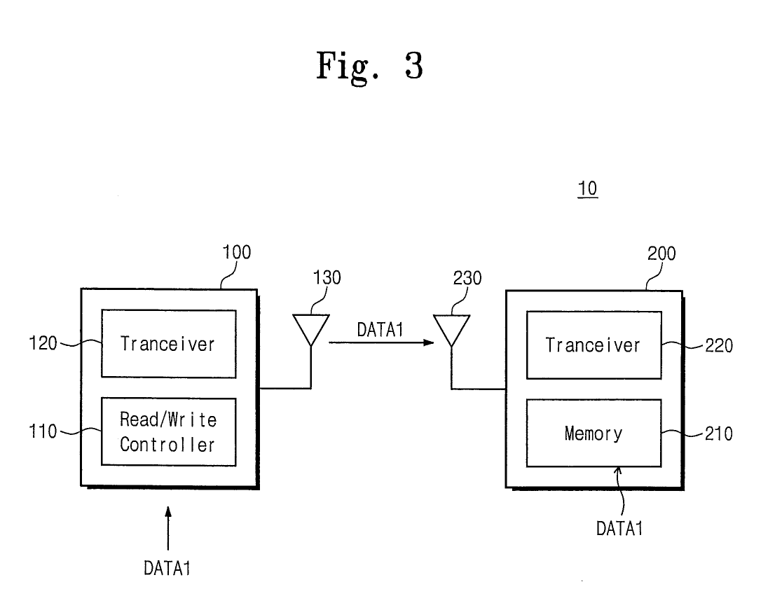

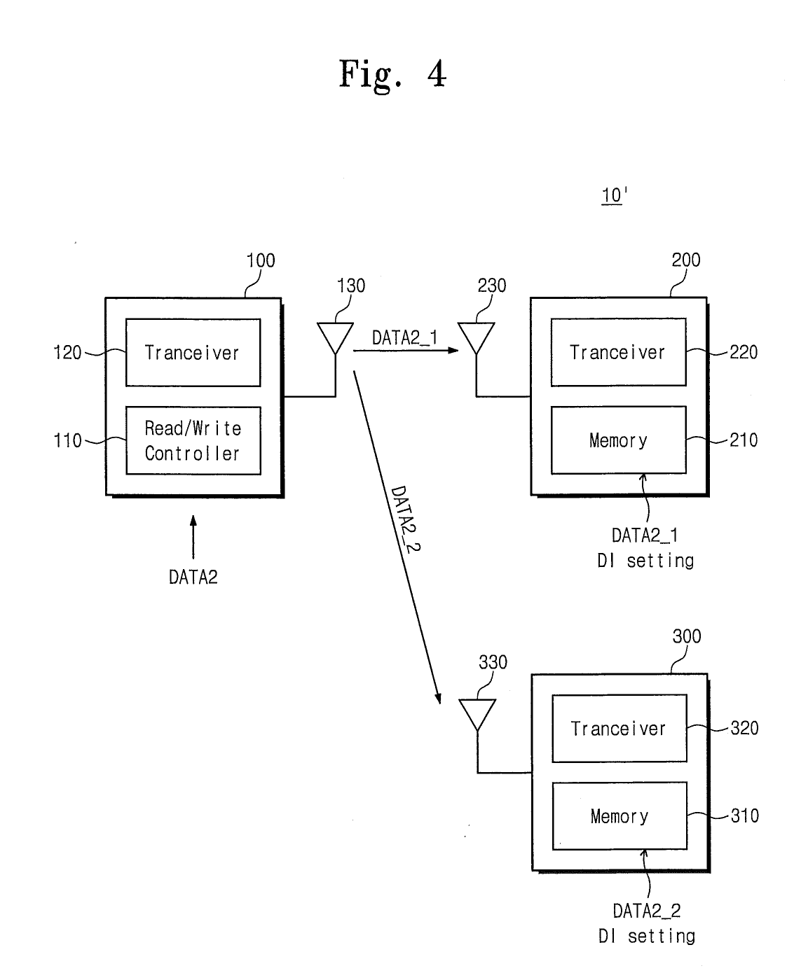

FIG. 2 is a flowchart illustrating a writing operation of the RFID system 10 of FIG. 1. FIGS. 3 and 4 are diagrams illustrating the operation of the RFID system 10 according to the flowchart of FIG. 2.

Referring to FIGS. 2 and 3, the RFID device 100 detects a storage capacity of the RFID tag 200 in step S110. For example, the RFID device 100 may detect data with respect to the storage capacity of the RFID tag 200 while identifying the RFID tag 200 in order to detect an identifier ID of the RFID tag 200.

In step S120, the RFID device 100 determines whether or not the storage capacity of the RFID tag 200 is less than the size of data DATA1 to be stored in the RFID tag 200. If the storage capacity of the RFID tag 200 is greater than the size of data DATA1 to be stored in the RFID tag 200, the process proceeds to step S160.

In step S160, the data DATA1 is written in the RFID tag 200. The data DATA1 is transmitted to the RFID tag 200 through a transceiver 120 and an antenna 130. The RFID tag 200 writes the data DATA1, which is transmitted through an antenna 230 and a transceiver 220, and stored in a memory 210.

Referring to FIGS. 2 and 4, assuming that the storage capacity of the RFID tag 200 is less than the size of data DATA2 to be stored in the RFID tag 200, that is, if the RFID device 100 determines that the storage capacity of the RFID tag 200 is less than the size of data DATA2 to be stored in the RFID tag 200, the process proceeds to step 5130.

In step 5130, RFID tags 200, including antenna 230, transceiver 220, and memory 210, and 300, including antenna 330, transceiver 320, and memory 310, are selected to store the data DATA2. The RFID device 100 may select the RFID tags 200 and 300 so that the total storage capacity of the RFID tags 200 and 300 is equal to or larger than the size of the data DATA2 to be stored in the RFID tags 200 and 300. For example, when the size of the data DATA2 to be stored in the RFID tags 200 and 300 is 8 MB, the RFID tags 200 and 300 each having the storage capacity of 4 MB may be selected. The RFID tag 200 having the storage capacity of 6 MB and the RFID tag 300 having the storage capacity of 2 MB may also be selected. If the total storage capacity of the RFID tags 200 and 300 is equal to or larger than the size of the data DATA2 to be stored in the RFID tags 200 and 300, the RFID tags 200 and 300 may be selected regardless of the storage capacity of each RFID tag 200 and 300.

In step S140, the RFID device 100 divides the data DATA2 based on the storage capacity of the RFID tags 200 and 300. For example, the RFID device 100 may divide the data DATA2 into data DATA2_1 corresponding to the storage capacity of the RFID tag 200 and data DATA2_2 corresponding to the storage capacity of the RFID tag 300. The RFID device 100 may generate division information DI to restore the data DATA2 by grouping the data DATA2_1 and the data DATA2_2. For example, the RFID device 100 may generate the data DATA2_1 and the data DATA2_2 by dividing the data DATA2 into the first part and the latter part.

However, the RFID device 100 may generate the data DATA2_1 and the data DATA2_2 by dividing the data DATA2 without being limited to the above-described method. Although the RFID device 100 generates the data DATA2_1 and the data DATA2_2 by dividing the data DATA2, example embodiments may be applicable to many types and forms of RFID devices that can group the data DATA2_1 and the data DATA2_2 and restore the data DATA2 using the division information DI.

In step S150, the RFID device 100 writes the data DATA2_1 generated from the data DATA2 in the RFID tag 200 and writes the data DATA2_2 generated from the data DATA2 in the RFID tag 300. Moreover, the RFID device 100 writes the division information DI in each of the RFID tags 200 and 300. The division information DI indicates which of the data DATA21 and DATA2_2 divided from the data DATA2 is stored in each of the RFID tags. The division information DI may include the total number of data DATA2_1 and DATA2_2 divided and generated from the data DATA2, that is, the total number of RFID tags 200 and 300 in which the data DATA2 may be stored. The division information DI may include information indicating which of the data DATA2_1 and DATA2_2 divided and generated from the data DATA2 is stored in each of the RFID tags.

For example, the division information DI stored in the RFID tag 200 may include the total number of data DATA2_1 and DATA2_2 divided and generated from the data DATA2, for example, “2”. The division information DI stored in the RFID tag 200 may include information about whether or not the data DATA2_1 of the data DATA2_1 and DATA2_2 is stored, for example, “1”. That is, the division information DI stored in the RFID tag 200 may store “2-1” as a “data number-data sequence”.

For example, the division information DI stored in the RFID tag 300 may include the total number of data DATA2_1 and DATA2_2 divided and generated from the data DATA2, for example, “2”. The division information DI stored in the RFID tag 300 may include information about whether or not the data DATA2_2 of the data DATA2_1 and DATA2_2 is stored, for example, “2”. That is, the division information DI stored in the RFID tag 300 may store “2-2” as a “data number-data sequence”.

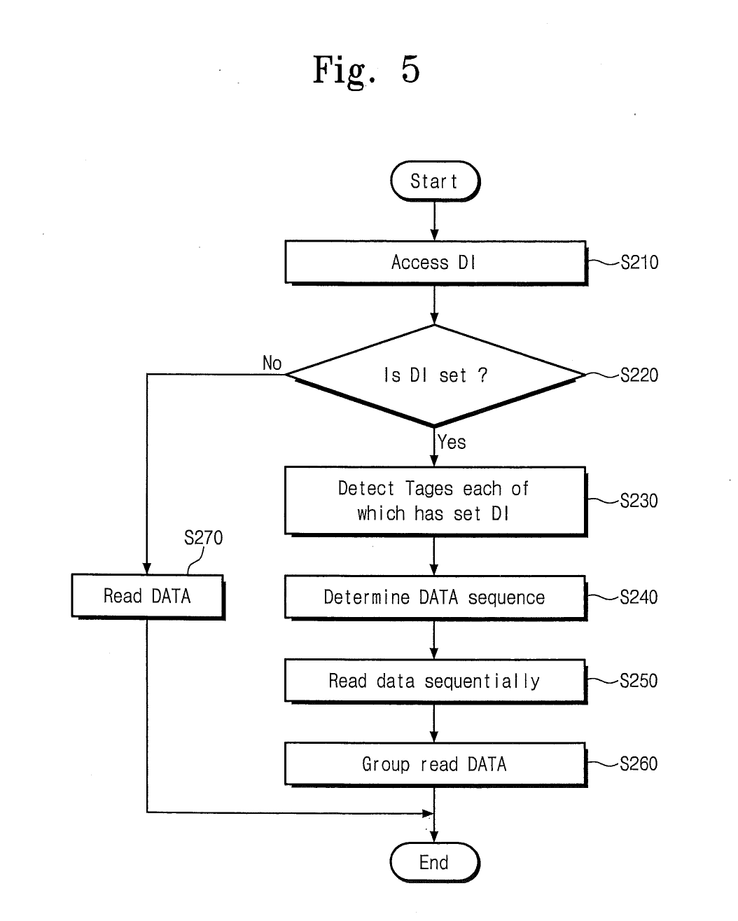

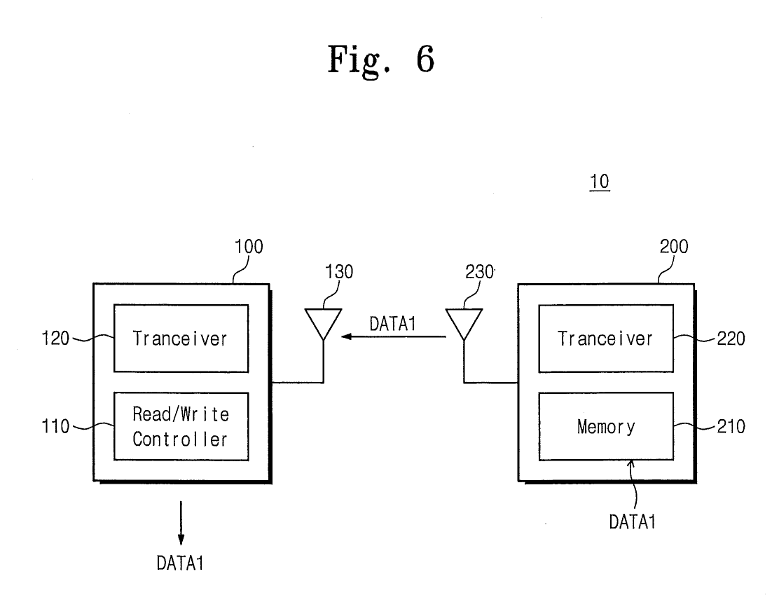

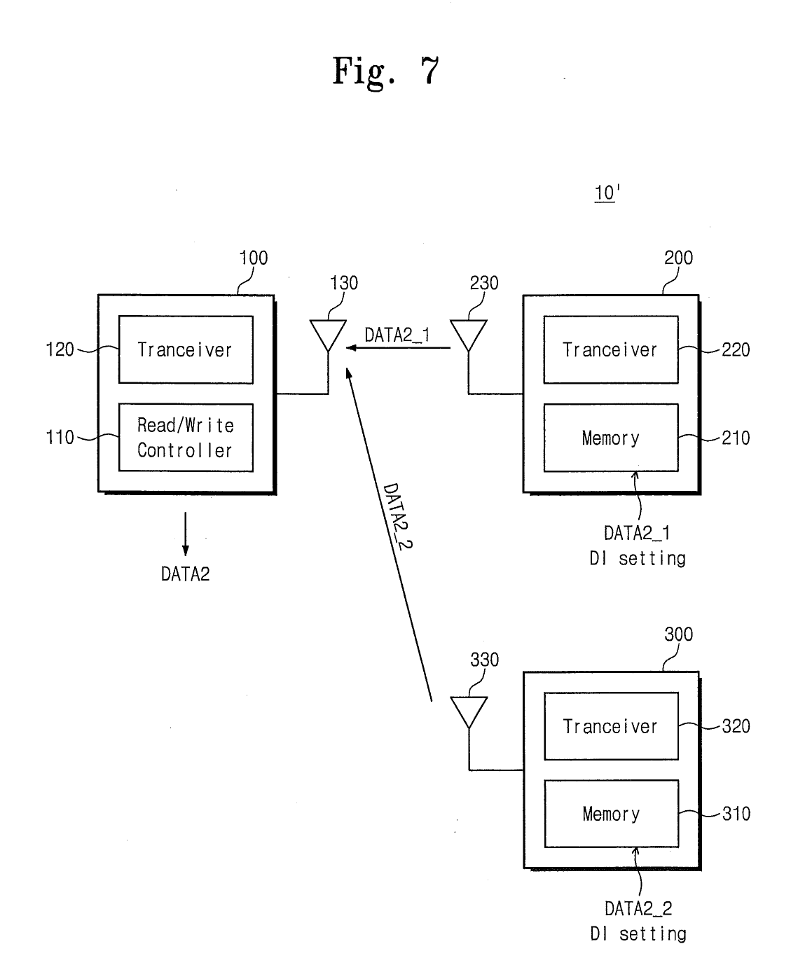

FIG. 5 is a flowchart illustrating a reading operation of the RFID system 10 of FIG. 1. FIGS. 6 and 7 are diagrams illustrating the operation of the RFID system 10 according to the flowchart of FIG. 5.

FIGS. 5 and 6 illustrate an example embodiment of the reading operation of the RFID device 100 according to the example embodiment. In the example embodiment of the reading operation of the RFID device 100, the data DATA1 is stored in one RFID tag 200 as described with reference to FIGS. 2 and 3.

In step S210, the RFID device 100 accesses the division information DI of the RFID tag 200. In step S220, the RFID device 100 determines whether or not the division information DI of the RFID tag 200 is set. As described with reference to FIGS. 2 and 3, if the data DATA1 is stored one RFID tag 200, the division information DI is not set. Therefore, the process proceeds to step S270. In step S270, the RFID device 100 reads the data DATA1 stored in the RFID tag 200. Since the data DATA1 is stored in one RFID tag 200, when the RFID device 100 reads the RFID tag 200, the reading operation of the data DATA1 may be completed.

FIGS. 5 and 7 illustrate another embodiment of the reading operation of the RFID device 100 according to the example embodiment. In the example embodiment of the reading operation of the RFID device 100, the data DATA2 is divided into the data DATA2_1 and the data DATA2_2 and the divided data DATA2_1 and DATA2_2 are stored in the RFID tags 200 and 300, respectively, as described with reference to FIGS. 2 and 4.

In step S210, the RFID device 100 accesses the division information DI of the RFID tag 200, the RFID tag 300, or the RFID tags 200 and 300. In step S220, the RFID device 100 determines whether or not the division information DI of the RFID tag 200, the RFID tag 300, or the RFID tags 200 and 300 is set. That is, the RFID device 100 may access the division information DI of the RFID tag locating within the communicable range. As described with reference to FIGS. 2 and 4, if each division information DI (for example, “2-1” and “2-2”) is set, the process proceeds to step S230.

In step S230, the RFID device 100 detects the RFID tags 200 and 300 in which the division information DI is set. Suppose that the RFID tag 200 is detected in steps S210 and 5220. The RFID tag 200 stores “2-1” as division information DI. That is, the division information DI of the RFID tag 200 indicates that one of two data DATA2_1 and DATA2_2 divided from the original data DATA2 is stored in the RFID tag 200. Accordingly, the RFID device 100 may detect the RFID tag 300 storing the data DATA2_2 of two data DATA2_1 and DATA2_2 divided from the original data DATA2. The RFID device 100 may detect the RFID tag 300 storing “2-2” as division information DI.

Similarly, the RFID device 100 may detect the RFID tag 200 using the division information DI in step 5230, when the RFID device 100 accesses the division information DI, which is stored in the RFID tag 300, in steps S210 and S220. Step S230 may be omitted when the RFID device 100 accesses the division information DI stored in the RFID tags 200 and 300 in steps S210 and 5220.

In step S240, the RFID device 100 determines the sequence of the data DATA2_1 and DATA2_2 stored in the RFID tags 200 and 300. The RFID device 100 may determine the data DATA2_1 and DATA2_2 using the division information DI of each RFID tag.

As described above, the division information DI may include “data number data sequence”. The RFID tag 200 may store “2-1” as division information DI, and the RFID tag 300 may store “2-2” as division information DI. The RFID device 100 may determine the sequence of the data DATA2_1 and DATA2_2 stored in the RFID tags 200 and 300 using the division information DI of the RFID tags 200 and 300. That is, the RFID device 100 may determine the data DATA2_1 stored in the RFID tag 200 as a first data and determine the data DATA2_2 stored in the RFID tag 300 as a second data.

In step S250, the RFID device 100 reads out sequentially the data DATA2_1 and DATA2_2 stored in the RFID tags 200 and 300. The RFID device 100 reads the data DATA2_1 from the RFID tag 200 and then reads the data DATA2_2 from the RFID tag 300. The data DATA2_1 and DATA2_2 read from the RFID tags 200 and 300 may be stored in a buffer (not shown) of the RFID device 100. Since the data DATA2_1 and DATA2_2 are sequentially read from the RFID tags 200 and 300, if the data DATA2_1 and DATA2_2 are stored, the data DATA2 may be restored by grouping the read data in step S260. That is, the RFID device 100 divides sequentially the data DATA2 into the data DATA2_1 and DATA2_2, stores the data DATA2_1 and DATA2_2 in the RFID tags 200 and 300, reads sequentially the data DATA2_1 and DATA2_2 stored in the RFID tags 200 and 300, and restores the data DATA2.

The RFID device 100 may also store the data DATA2_1 and DATA2_2, which are read from the RFID tags 200 and 300, in the buffer and restore the data DATA2 using the division information DI of the RFID tags 200 and 300. If the division information DI includes the information about a method of generating the data DATA2_1 and DATA2_2 by dividing the data DATA2, the data DATA2_1 and DATA2_2 may have no need to be sequentially divided from the data DATA2.

According to the above-described example embodiment, the data DATA2_1 and DATA2_2 divided from the data DATA2 are stored in the RFID tags 200 and 300, respectively. However, the data may be stored in the RFID tags without being limited to the example described above. For example, the data to be stored in the RFID tags may be divided into any number of positive integers depending on the storage capacity of the RFID tags.

According to the example embodiments, the data DATA1 having a size less than the storage capacity of the RFID tag 200 may be stored in the RFID tag 200, while the data DATA2 having a size larger than the storage capacity of the RFID tag 200 may be divided into the data DATA2_1 and DATA2_2 and stored in the RFID tag 300. However, the data DATA1 may be coded to reduce noises, the effect of channel, and the interference from other signals and may then be stored in the RFID tag 200. In addition, the data DATA2 may be divided into the data DATA2_1 and DATA2_2 and may be stored in the RFID tag 200 by coding the divided data to reduce noises, the effect of channel, and the interference from other signals.

Furthermore, the data DATA1 may be coded to be stored in the RFID tag 200, and the data DATA2_1 and DATA2_2 may be coded to be stored in the RFID tags 200 and 300, respectively.

According to the example embodiments, when the size of the data DATA1 to be stored in the RFID tag 200 is less than the storage capacity of the RFID tag 200, the data DATA1 may be stored in the RFID tag 200, and the division information DI of the RFID tag 200 may not be set separately. However, when the data DATA1 is stored in the RFID tag 200, the data may set the information indicating that the data DATA1 is not divided to be stored in the RFID tag 200.

According to the example embodiments, the RFID device 100 may set the division information DI of the RFID tags 200 and 300 during the writing operation, but the RFID device 100 accesses the division information DI of the RFID tags 200 and 300 during the reading operation. That is, the storage area of the RFID tags 200 and 300, which stores the division information DI, is known so that the RFID device 100 can access the tags. For example, a specific address of the RFID tags 200 and 300 may be known so as to store the division information DI.

According to the example embodiments, the division information DI may include “data number-data sequence”, but is not limited thereto. The division information DI may include the information (for example, data ID) about the data DATA2 stored in the RFID tags 200 and 300.

For example if the data DATA2 is divided into the data DATA2_1 and DATA2_2 to be stored in the RFID tags 200 and 300. The division information DI of the RFID tags 200 and 300 may include “data ID-data number-data sequence”. For example, the division information DI of the RFID tags 200 and 300 may include “DATA2, 2, 1” and “DATA2, 2, 2”.

For example if the data DATA3 is divided into data DATA3_1 and DATA3_2 to be stored in other RFID tags (not shown). The division information DI of the RFID tags storing the data DATA3_1 and DATA3_2 may include “data ID-data number-data sequence”. For example, the division information DI of the RFID tags storing the data DATA3_1 and DATA3_2 may include “DATA3, 2, 1” and “DATA3, 2, 2”.

Different data may be stored in, for example, the RFID tag 200 storing the data DATA2_1, the RFID tag storing the data DATA3_1, the RFID tag 300 storing the data DATA2_2, and the RFID tag storing the data DATA3_2 by adding the data ID to the division information DI.

The RFID system according to the example embodiments may include at least one RFID tag and an RFID device for accessing the RFID tag. The RFID device may compare a size of data to be stored in the RFID tag with a storage capacity of the RFID tag and divides the data based on compared results to write in the at least one RFID tag. Accordingly, the data storage efficiency of the RFID device and system may be improved.

Although example embodiments have been described in connection with the accompanying drawings, it is not limited thereto. It will be apparent to those skilled in the art that various substitutions, modifications and changes in form may be made therein without departing from the scope and spirit of the claims.

What is claimed is:

1. A method of operating a Radio Frequency Identification (RFID) device, the method comprising:
dividing a data to be stored in one or more RFID tags; and
transmitting the divided data to the RFID tags so as to write the divided data in the RFID tags.

2. The method of claim 1, further comprising:
reading a written data from the one or more RFID tags; and
combining the read data to output as a read data.

3. A method of writing data to one or more Radio Frequency Identification (RFID) tags, the method comprising:
detecting the storage capacity of the RFID tags;
transmitting the data to be stored to a one RFID tag if a size of the data to be stored is less than a data storage capacity of the one RFID tag, so as to write the data to be stored in the one RFID tag;
selecting at least two RFID tags of the RFID tags if the size of the data to be stored is larger than the capacity of the RFID tags, a capacity of the at least two RFID tags being greater than the data to be stored;
dividing the data to be stored based on the capacity of the at least two RFID tags; and
transmitting the divided data to the at least two RFID tags so as to write the data to be stored in the at least two RFID tags.

4. The method of claim 3, further comprising:
writing a division information in each of the at least two RFID tags, the division information indicating that the data to be stored is divided in the at least two RFID tags.

5. The method of claim 4, wherein the division information includes,
a number of RFID tags in which the divided data is written, and
information indicating which of the one or more RFID tags includes the divided data.
